(19) United States
(12) Patent Application Publication
(10) Pub. No.: US 2007/0049153 A1
(43) Pub. Date: Mar. 1, 2007

(54) Textured wiper material with multi-modal pore size distribution

(76) Inventors: Charlene Harris Dunbar, Lilburn, GA (US); Alan E. Wright, Woodstock, GA (US)

Correspondence Address: KIMBERLY-CLARK WORLDWIDE, INC., 401 NORTH LAKE STREET, NEENAH, WI, 54956, US

(21) Appl. No.: 11/216,646

(22) Filed: Aug. 31, 2005

(51) Int. Cl. B32B 3/28; D04H 1/56

(52) U.S. Cl. 442/400; 428/180

(57) ABSTRACT

Disclosed herein are textured nonwoven wiper materials. The textured nonwoven wiper material includes a meltblown nonwoven web material that has a first exterior surface and a second exterior surface, and at least the first exterior surface of the meltblown nonwoven web is a three-dimensional textured surface. The textured meltblown nonwoven web has a multi-modal pore size distribution that includes at least two major pore size peaks.

### BACKGROUND OF THE INVENTION

Fibrous nonwoven materials and fibrous nonwoven composite materials are widely used as products, or as components of products, such as dry wipes and wet wipes because they can be manufactured inexpensively and made to have specific characteristics. Because of the relative inexpense of these products in relation to woven or knitted cloth wiper materials, they can viewed as disposable materials that can be discarded once soiled, as opposed to reusable materials that must be laundered when soiled.

One approach to making fibrous nonwoven materials for wipes is the use of homogeneous mixtures of materials such as air laid webs or coformed webs of fibers mixed with cellulosic fibers or another absorbent material. Other wipes have been prepared by joining different types of nonwoven materials together into a laminate or formed as a layered structure. These products can be prepared from thermoplastic materials such as plastic sheets, films and nonwoven webs, prepared by extrusion processes such as, for example, slot film extrusion, blown bubble film extrusion, meltblowing and spunbonding of nonwoven webs.

Saturated or pre-moistened paper and textile cloth wipers have been used in a variety of wiping and polishing cloths. These substrates are often provided in a sealed container and retrieved therefrom in a moist or saturated condition (i.e., pre-moistened). The pre-moistened cloth or paper wiper releases the retained liquid when used to clean or polish the desired surface. In addition, meltblown fiber webs have also been used as pre-moistened wipers in various applications and end uses. It is known that meltblown fiber fabrics are capable of receiving and retaining liquids for extended periods of time.

However, while meltblown webs provide desirable liquid retention characteristics, meltblown fabrics also provide a metered release of the liquid retained therein. Thus, in use it is often difficult to achieve a quick and substantial release of the liquid from the meltblown web. Meltblown nonwoven webs generally also have fairly uniform or flat surfaces, and so are also not effective in trapping and removing particles of different sizes or viscous liquids.

Therefore, there remains a need for new materials capable of holding and retaining a pre-moistening liquid, while also capable of providing a quick, substantial release of the liquid. Furthermore there remains a need for new materials capable of providing a textured surface capable of scrubbing soiled surfaces and trapping and removing particulate matter from the soiled surfaces.

### SUMMARY OF THE INVENTION

The present invention provides a three-dimensionally textured nonwoven wiper material. The textured nonwoven wiper material includes a meltblown fibrous nonwoven web material having a first exterior surface and a second exterior surface. At least one of the first and second exterior surfaces has a three-dimensional surface texture. In addition, the textured meltblown nonwoven web has a multi-modal pore size distribution that includes at least two major peaks. In one aspect of the textured nonwoven wiper material of the invention, the textured meltblown fibrous nonwoven web material has a multimodal pore size distribution wherein at least one of the major pore size peaks has a mean equivalent pore radius of greater than about 100 microns, and at least a second of the major pore size peaks has a mean equivalent pore radius of less than about 100 microns. In embodiments, desirably the major pore size peak having the smaller equivalent pore radius may have an equivalent pore radius of less than about 80 microns, and in other embodiments the major peak having the smaller equivalent pore radius may have an equivalent pore radius of less than about 60 microns, or even less than about 40 microns.

In addition, the major pore size peak having the greater equivalent pore radius may desirably have an equivalent pore radius of greater than about 120 microns, and in still other embodiments the major peak having the greater equivalent pore radius may have an equivalent pore radius of greater than about 140 microns, or even greater than about 160 microns.

In another aspect of the textured nonwoven wiper material of the invention, the textured meltblown fibrous nonwoven web material has a multi-modal pore size distribution with at least first and second major peaks, wherein at least one second major pore size peaks has a mean equivalent pore radius that is at least about 60 microns greater than the mean equivalent pore radius of a first major peak. In embodiments, desirably the second major peak's mean equivalent pore radius may be at least about 70 microns greater than the first major peak's mean equivalent pore radius, and in still other embodiments, the second major peak's mean equivalent pore radius may be at least about 80, 90, 100, 110 or even 120 or more microns larger than the first major peak's mean equivalent pore radius.

In either aspect, the textured meltblown nonwoven web of the textured nonwoven wiper material may be desirably produced from thermoplastic polymers, such as, for example, polyolefin thermoplastic polymers such as polypropylene, polybutylene, polyethylene, and the like, and may also include blends of thermoplastic polymers. In addition, wipers including the textured nonwoven wiper material are included herein, and such materials and wipers may desirably further include a moistening liquid, for example may include from about 50 percent to about 900 percent of a moistening liquid (percent by weight of the wiper material itself). Further included herein are packages of wipers comprising a plurality of the textured nonwoven wiper material of the invention.

### BRIEF DESCRIPTION OF THE DRAWINGS

FIG. 1 illustrates in cross-sectional view an exemplary textured nonwoven wiper material according to the present invention.

FIG. 2 schematically illustrates in top plan view an exemplary process for producing the textured nonwoven wiper material of the present invention.

FIG. 3 and FIG. 4 are graphs of pore size distributions for Comparative and Example materials, respectively.

FIG. 5 illustrates in side view a schematic of another exemplary process for producing the textured nonwoven wiper material of the present invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries. As used herein the term “thermoplastic” or “thermoplastic polymer” refers to polymers that will soften and flow or melt when heat and/or pressure are applied, the changes being reversible.

As used herein the term “fibers” refers to both staple length fibers and substantially continuous filaments, unless otherwise indicated. As used herein the term “substantially continuous” with respect to a filament or fiber means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer composition. This is not meant to exclude fibers or filaments formed from one polymeric extrudate to which small amounts of additives have been added for color, anti-static properties, lubrication, hydrophilicity, etc.

As used herein the term “multicomponent fibers” refers to fibers or filaments that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side by side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein the terms “biconstituent fiber” or “multiconstituent fiber” refer to a fiber or filament formed from at least two polymers, or the same polymer with different properties or additives, extruded from the same extruder as a blend. Multiconstituent fibers do not have the polymer components arranged in substantially constantly positioned distinct zones across the cross-section of the multicomponent fibers; the polymer components may form fibrils or protofibrils that start and end at random.

As used herein the terms “nonwoven web” or “nonwoven fabric” refer to a web having a structure of individual fibers or filaments that are interlaid, but not in an identifiable manner as in a knitted or woven fabric. Nonwoven fabrics or webs have been formed from many processes such as for example, meltblowing processes, spunbonding processes, airlaying processes, and carded web processes. The basis weight of nonwoven fabrics is usually expressed in grams per square meter (gsm) or ounces of material per square yard (osy) and the filament diameters useful are usually expressed in microns. (Note that to convert from osy to gsm, multiply osy by 33.91).

The terms “spunbond” or “spunbond nonwoven web” refer to a nonwoven fiber or filament material of small diameter fibers that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,692,618 to Dorschner et al., and U.S. Pat. No. 3,802,817 to Matsuki et al., all incorporated herein by reference in their entireties. Typically, spunbond fibers or filaments have a weight-per-unit-length in excess of about 1 denier and up to about 6 denier or higher, although both finer and heavier spunbond fibers can be produced. In terms of fiber diameter, spunbond fibers often have an average diameter of larger than 7 microns, and more particularly between about 10 and about 25 microns, and up to about 30 microns or more.

As used herein the term “meltblown fibers” means fibers or microfibers formed by extruding a molten thermoplastic material through a plurality of fine, usually circular, die capillaries as molten threads or filaments or fibers into converging high velocity gas (e.g. air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are often smaller than 10 microns in average diameter and are frequently smaller than 7 or 5 microns in average diameter, or even smaller than 3 microns in average diameter, and are generally tacky when deposited onto a collecting surface.

As used herein “carded webs” refers to nonwoven webs formed by carding processes as are known to those skilled in the art and further described, for example, in U.S. Pat. No. 4,488,928 to Alikhan and Schmidt which is incorporated herein in its entirety by reference. Briefly, carding processes involve starting with staple fibers in a bulky batt that is combed or otherwise treated to provide a web of generally uniform basis weight. Typically, the webs are thereafter bonded by such means as through-air bonding, thermal point bonding, adhesive bonding, and the like.

As used herein “coform” or “coformed web” refers to composite nonwoven webs formed by processes in which two or more fiber types are intermingled into a heterogeneous composite web, rather than having the different fiber types supplied as separate or distinct web layers, as is the case in a laminate composite material. Certain well-known coform processes are described in U.S. Pat. No. 4,818,464 to Lau, U.S. Pat. No. 4,100,324 to Anderson et al., and U.S. Pat. Nos. 5,508,102 and 5,350,624 to Georger et al., the disclosures of which are incorporated herein by reference in their entireties, wherein at least one meltblowing diehead is arranged near a chute or other delivery device through which other materials or fiber types are added while the web is being formed. Such other materials or fiber types disclosed in these patents include staple fibers, cellulosic fibers, and/or superabsorbent materials and the like. The other fibers are interconnected by and held captive within a matrix of microfibers, such as meltblown microfibers, by mechanical entanglement of the microfibers with the other fibers, the mechanical entanglement and interconnection of the microfibers and other fibers alone forming a coherent integrated composite fibrous web structure.

As used herein, “airlaying” or “airlaid” involves a process and web by which a fibrous nonwoven layer can be formed. In the airlaying process, bundles of small fibers having typical lengths ranging from about 3 to about 19 millimeters (mm) are separated and entrained in an air supply or air stream and then deposited onto a forming screen, usually with the assistance of a vacuum supply. The randomly deposited fibers then are bonded to one another using, for example, hot air or a spray adhesive.

As used herein, “thermal point bonding” involves passing a fabric or web of fibers or other sheet layer material to be bonded between a heated calender roll and an anvil roll. The calender roll is usually, though not always, patterned on its surface in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30 percent bond area with about 200 bonds per square inch (about 31 bonds per square centimeter) as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen and Pennings or “EHP” bond pattern that produces a 15 percent bond area with a square pin having a side dimension of 0.037 inches (0.94 mm), a pin spacing of 0.097 inches (2.464 mm) and a depth of 0.039 inches (0.991 mm). Other common patterns include a high density diamond or “HDD pattern”, that comprises point bonds having about 460 pins per square inch (about 71 pins per square centimeter) for a bond area of about 15 percent to about 23 percent, a “Ramish” diamond pattern with repeating diamonds having a bond area of about 8 percent to about 14 percent and about 52 pins per square inch (about 8 pins per square centimeter) and a wire weave pattern looking as the name suggests, e.g. like a window screen. As still another example, the nonwoven web may be bonded with a point bonding method wherein the arrangement of the bond elements or bonding “pins” are arranged such that the pin elements have a greater dimension in the machine direction than in the cross-machine direction. Linear or rectangular-shaped pin elements with the major axis aligned substantially in the machine direction are examples of this. Alternatively, or in addition, useful bonding patterns may have pin elements arranged so as to leave machine direction running “lanes” or lines of unbonded or substantially unbonded regions running in the machine direction, so that the nonwoven web material has additional give or extensibility in the cross machine direction. Such bonding patterns as are described in U.S. Pat. No. 5,620,779 to Levy et al., incorporated herein by reference in its entirety, may be useful, such as for example the “rib-knit” bonding pattern therein described. Typically, the percent bonding area varies from around 10 percent to around 30 percent or more of the area of the fabric or web. Thermal bonding imparts integrity to individual layers or webs by bonding fibers within the layer and/or for laminates of multiple layers, such thermal bonding holds the layers together to form a cohesive laminate material.

### DETAILED DESCRIPTION OF THE INVENTION

The present invention provides a three-dimensionally textured nonwoven wiper material. The textured nonwoven wiper material includes a meltblown fibrous nonwoven web material having a first exterior surface and a second exterior surface. At least one of the first and second exterior surfaces has a three-dimensional surface texture. In addition, the textured meltblown nonwoven web has a multi-modal pore size distribution that includes at least two major peaks as hereinbelow described.

It will be apparent to those skilled in the art that the embodiments described herein do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and equivalents. In addition, it should be noted that any given range presented herein is intended to include any and all lesser included ranges. For example, a range of from 45-90 would also include 50-90; 45-80; 46-89 and the like. Thus, the range of 95 percent to 99.999 percent also includes, for example, the ranges of 96 percent to 99.1 percent, 96.3 percent to 99.7 percent, and 99.91 percent to 99.999 percent, etc.

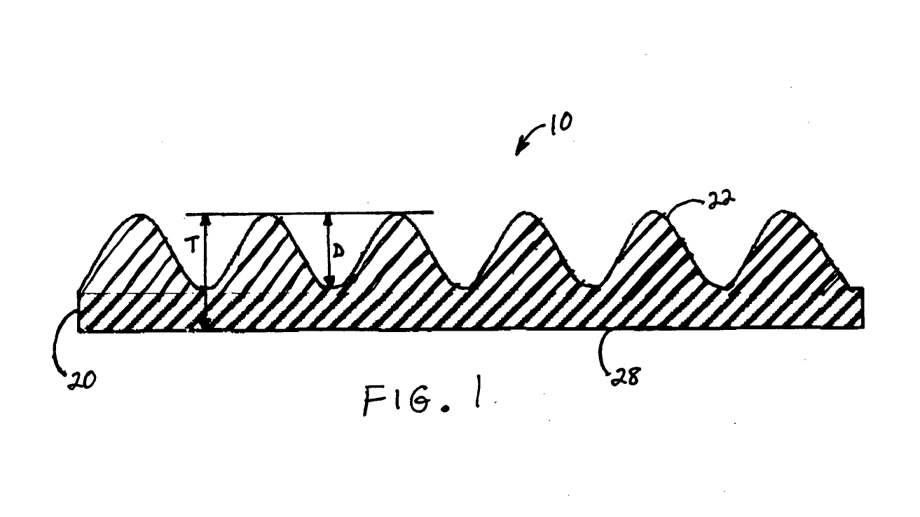

FIG. 1 shows an illustration of a cross section of a textured nonwoven wiper material according to the present invention, the wiper material generally designated 10. The textured nonwoven wiper material 10 includes a meltblown fibrous nonwoven web material 20. The meltblown fibrous nonwoven web material 20 has a first exterior surface 22 and a second exterior surface 28. As mentioned above, least one of the first 22 and second 28 exterior surfaces has a three-dimensional surface texture. As shown in FIG. 1, the first exterior surface 22 of meltblown fibrous nonwoven web material 20 has a three-dimensional surface texture. In addition, the meltblown nonwoven web has a multi-modal pore size distribution that includes at least two major pore size peaks as hereinbelow described.

As stated, at least the first surface 22 has a three dimensional surface texture. As shown in FIG. 1, the first surface 22 includes tufts or peaks 24 that extend upwardly from the plane of the meltblown web material. Also illustrated in FIG. 1 are the dimensions D, T, wherein D is a measure of the height of peaks (or, conversely, a measure of the depth of “valleys” between peaks) and T is a measure of the total thickness dimension of the meltblown fibrous nonwoven web material including the peaks.

A useful indication of the magnitude of three-dimensionality in the textured exterior surface(s) of the meltblown fibrous nonwoven web material is the peak to valley ratio. The peak to valley ratio is calculated as the ratio including the overall thickness T divided by the valley depth D. Desirably, the peak to valley ratio should be about 6 or less. As an example, for a textured meltblown fibrous nonwoven web material having an overall average thickness T of 2 millimeters and having tufts that are about 0.33 millimeters tall (i.e., an average valley depth D of 0.33 millimeters), the peak to valley ratio of the textured meltblown material is 6. It is still more desirable for the textured meltblown fibrous nonwoven web material to have peaks or tufts that are taller in relation to the overall thickness of the material, and therefore the peak to valley ratio is more desirably about 5 or less, and still more desirably about 4 or less. As an example, for a textured meltblown fibrous nonwoven web material having an overall average thickness T of 2 millimeters and an average valley depth D of 0.5 millimeters, the peak to valley ratio of the textured meltblown material is 4.

Depending on the contemplated end use of the wiper material, the peak to valley ratio of the textured meltblown fibrous nonwoven web material may desirably be as low as 3, or lower, or as low as 2 or lower. As an example, for a textured meltblown fibrous nonwoven web material having an overall average thickness T of 2 millimeters and an average valley depth D of 1 millimeter, the peak to valley ratio of the meltblown material is 2. It is further contemplated that the textured meltblown fibrous nonwoven web material may have tufts that are taller than half of the overall thickness dimension of the material, and therefore the peak to valley ratio may also desirably be less than 2. As an example, for a textured meltblown fibrous nonwoven web material having an overall thickness T of 1.5 millimeters and an average valley depth D of 1.1 millimeter, the peak to valley ratio is about 1.36.

The textured meltblown fibrous nonwoven web material may additionally exhibit three-dimensional texture on the second surface of the meltblown web. This will especially be the case for lower basis weight materials, such as those having a basis weight of less than about 2 osy (about 68 gsm) due to “mirroring” where the second surface of the material exhibits peaks offset or between peaks on the first exterior surface of the material. In this case, the valley depth D is measured for both exterior surfaces as above and are then added together to determine an overall material valley depth.

The peak to valley ratio may be calculated for a textured meltblown fibrous nonwoven web material by taking one or more samples of the meltblown material and cutting a cross section down through the thickness dimension for examination. It may desirable to immerse such samples in liquid nitrogen just prior to cutting the cross section, to avoid undue crushing or flattening of the tufts or peaks. The cut cross section may then be viewed edge-on by methods such as light microscopy or by scanning electron microscopy. It is useful to obtain photographs or micrographs of the cross section of the material for purposes of measuring the dimensions T, D. The valley depth D is the distance from the base of the valley to a line drawn tangential to two neighboring peak tops. Valley depth D is measured along a line perpendicular to the sheet plane of the meltblown material. The meltblown material thickness T is the overall thickness of the material including the peak heights, and is also measured along a line perpendicular to the sheet plane of the meltblown material that runs from the base or bottom of the meltblown material to the line drawn tangential to two neighboring peak tops. Or, where both exterior surfaces include texturing, a line may be drawn tangential to two neighboring peak tops on the first exterior surface, and a line drawn tangential to two neighboring peak tops on the second exterior surface, and the meltblown material thickness T is then the overall thickness measured along a line perpendicular to the sheet plane of the material between these two tangential lines. Generally speaking, the peak to valley ratio should be calculated from an average valley depth D and an average thickness T, wherein D and T are averages of at least about 20 individual measurements of valley depth or meltblown material thickness, respectively.

Returning to FIG. 1, the number and arrangement of the tufts or peaks 24 may vary widely depending on the desired end use. Generally, the textured meltblown fibrous nonwoven web material 10 will have between about 10 and about 400 tufts or peaks 24 per square inch (between approximately 2 and about 62 tufts per square centimeter). More particularly, the textured meltblown fibrous nonwoven web material will have between about 50 and 200 tufts or peaks per square inch (between about 7.8 and about 31 tufts per square centimeter).

As stated above, the textured nonwoven wiper material includes a textured meltblown fibrous nonwoven web material. The textured meltblown fibrous nonwoven web material itself has a multi-modal pore size distribution, that is, the meltblown material has a pore size distribution that includes at least two major pore size peaks. This is in contrast to a wiper that may have more than one major pore size peaks because the wiper is a laminate of one material having one pore size peak, and another material having a second distinct pore size peak. Rather, in the present invention, the single meltblown fibrous nonwoven web material has two or more distinct pore size peaks. By “major peak”, what is meant is a pore size peak that includes a significant amount of the pore volume of the web. As a specific example, a major peak should encompass at least about 10 percent of the pore volume of the web material itself. Desirably, a major peak should encompass more than 10 percent of the pore volume, such as at least about 11 percent, or at least about 12 percent, or at least about 13 percent of the pore volume of the material. Depending on the desired end use of the wiper material, and depending on the equivalent pore radius of a given major pore size peak, a major peak may desirably encompass at least about 15 percent or more of the pore volume of the web material itself, or 25 percent, 30 percent, 40 percent or more.

As an example, it may be desirable to have one major pore size peak of rather smaller equivalent pore radius encompassing, for example, a pore volume at the lower end of the ranges given (10 percent, 11 percent, 13 or 15 percent), and have a second major pore size peak of rather larger equivalent pore radius encompassing, for example, a pore volume at the upper ranges described above, or even higher. Alternatively, the rather smaller equivalent pore radius major pore size peak could encompass a large percentage of the wiper material's pore volume while the rather larger equivalent pore radius major pore size peak could encompass a large percentage of the wiper material's pore volume. Other alternatives are possible.

The pore size distribution of a fibrous nonwoven web structure is related to the capillarity of the material. Capillarity is defined as the propensity of the structure to absorb or hold fluids and is typically expressed as capillary pressure. The mean equivalent pore radius may be measured by a capillary tension method. In this method, capillary tension is based on the LaPlace equation wherein:
Capillary Pressure=2*[(liquid surface tension)*cos(contact angle)]/r,

And so the radius “r” may be expressed as:
r=2*(liquid surface tension)*cos(contact angle))/Capillary Pressure

The mean equivalent pore radius may be measured using an apparatus described further in an article by Burgeni and Kapur, in the Textile Research Journal, Volume 37, pp. 356-366 (1967), the disclosure of which is incorporated by reference. The apparatus includes a movable stage interfaced with a programmable stepper motor, and an electronic balance controlled by a computer. A control program automatically moves the stage to a desired height, collects data at a specified sampling rate until equilibrium is reached, and then moves the stage to the next calculated height. Controllable parameters include sampling rates, criteria for equilibrium and the number of absorption/desorption cycles. In addition, the mean equivalent pore radius may be measured substantially in accordance with ASTM F316 (2003), and capillary porometers capable of measuring the mean equivalent pore radius and pore volume in a web material are available from companies such as Xonics, Ltd. (Hampshire, England) and Porous Materials, Inc., (Ithaca, N.Y.).

In one aspect of the textured nonwoven wiper material of the invention, the textured meltblown fibrous nonwoven web material has a multimodal pore size distribution wherein at least one of the major pore size peaks has a mean equivalent pore radius of greater than about 100 microns, and at least a second of the major pore size peaks has a mean equivalent pore radius of less than about 100 microns. In embodiments, desirably the major pore size peak having the smaller equivalent pore radius may have an equivalent pore radius of less than about 80 microns, and in other embodiments the major peak having the smaller equivalent pore radius may have an equivalent pore radius of less than about 60 microns, or even less than about 40 microns. In addition, the major pore size peak having the greater equivalent pore radius may desirably have an equivalent pore radius of greater than about 120 microns, and in still other embodiments the major peak having the greater equivalent pore radius may have an equivalent pore radius of greater than about 140 microns, or even greater than about 160 microns.

In another aspect of the textured nonwoven wiper material of the invention, the textured meltblown fibrous nonwoven web material has a multi-modal pore size distribution with at least first and second major peaks, wherein at least one second major pore size peak has a mean equivalent pore radius that is at least about 60 microns greater than the mean equivalent pore radius of a first major peak. In embodiments, desirably the second major peak's mean equivalent pore radius may be at least about 70 microns greater than the first major peak's mean equivalent pore radius, and in still other embodiments, the second major peak's mean equivalent pore radius may be at least about 80, 90, 100, 110 or even 120 or more microns larger than the first major peak's mean equivalent pore radius.

The meltblown fibrous nonwoven web material in the textured nonwoven wiper material may be produced by meltblowing meltblown fibers from a single “bank” or single meltblowing diehead, or may be produced by meltblowing meltblown fibers from multiple meltblowing dieheads arranged in series along the machine direction (the direction of material production) of the production process. For example, the meltblown fibrous nonwoven web material may be produced from two meltblowing dieheads, three meltblowing dieheads, or even 4, 5 or 6 or more meltblowing dieheads arranged in series. In addition, the individual meltblowing dieheads in a multi-bank series may all produce meltblown fibers from the same thermoplastic polymer or polymer blend, or may be arranged such that one meltblowing diehead extrudes meltblown fibers comprising one type of polymer while one or more other meltblowing dieheads extrudes meltblown fibers comprising another distinct polymer. In this fashion, it is possible to tailor the functional properties of meltblown fibrous nonwoven web material to suit desired end needs.

As a specific example, it may be desirable to provide a meltblown fibrous nonwoven web material having a “softer” feeling side or exterior surface, which may be textured or non-textured, and a “coarser” feeling side or exterior surface, which side is desirably has a three-dimensional surface texture. As described in more detail below, polyolefins are known as useful thermoplastic fiber forming resins and polyethylene polymers, for example, are generally known to provide fibers and nonwoven materials having a softer hand-feel than polypropylene polymer, for example. Therefore, such a meltblown fibrous nonwoven web material as described could desirably comprise a softer exterior surface including meltblown fibers comprising polyethylene, and a coarser three-dimensional exterior surface or side including meltblown fibers comprising polypropylene. For such a wiper material, where the wiper is provided as a personal care wiper, the softer side may desirably be used for wiping more sensitive areas of a user's body, such as the face, while the coarser side or surface may desirably be used for wiping less sensitive areas, or areas that tend to be more heavily soiled, such as the user's hands. Other variations and combinations are possible. For example, polybutylene polymers such as poly(1-butene) and poly(2-butene), and copolymers of butylenes, such as ethylene-butylene copolymers, for example, are capable of providing a tougher or more resistant surface, and polybutylene polymers may therefore be desirable for use in a coarser three-dimensional textured exterior surface, either by using the polybutylene polymer alone for the textured surface or by using the polybutylene polymer in a blend with another suitable polymer, such as polypropylene.

Other combinations and variations and uses for such combinations and uses will be readily apparent to one skilled in the art. As another specific example, one or both of the exterior surfaces (whether having a three dimensional texture or not) of the meltblown fibrous nonwoven web material may be provided with additional coarse scrubbing ability, if desired, through the provision of a small amount of large diameter fibers on the surface. For example, coarser meltblown fibers having a larger diameter than those describe above, such as meltblown fibers having a diameter larger than 20 microns, or larger than 40 microns or larger than 60 microns, or even larger, may be extruded onto an exterior surface of the meltblown web material to provide additional scrubbing ability. Wiper materials that are meltblown webs having large diameter meltblown fibers on a surface are described in U.S. Pat. No. 4,833,003 to Win et al., incorporated herein by reference in its entirety.

The meltblown fibrous nonwoven web material in the textured nonwoven wiper material may desirably be formed from one or more thermoplastic polymers as are known in the art to be suitable as fiber-forming polymers. Polymers suitable for making polymeric fibrous webs include those polymers known to be generally suitable for making polymeric films and nonwoven webs such as spunbond, meltblown, carded webs and the like, and such polymers include for example polyolefins, polyesters, polyamides, polycarbonates and copolymers and blends thereof. It should be noted that the polymer or polymers may desirably contain other additives such as processing aids or treatment compositions to impart desired properties to the fibers, residual amounts of solvents, pigments or colorants and the like.

Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof.

In addition, many elastomeric polymers are known to be suitable as fiber forming polymers to make extensible and/or elastic nonwoven web materials, i.e., materials that exhibit properties of stretch and recovery. Thermoplastic polymer compositions may desirably comprise any elastic polymer or polymers known to be suitable elastomeric fiber or film forming resins such as, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from Kraton Polymers U.S., L.L.C. of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from the ExxonMobil Chemical Company of Houston, Tex., as well as blends. Still other elastomeric polymers are available, such as the elastic polyolefin resins available under the trade name VISTAMAXX from the ExxonMobil Chemical Company, Houston, Tex., and the polyolefin (propylene-ethylene copolymer) elastic resins available under the trade name VERSIFY from Dow Chemical, Midlands, Mich.

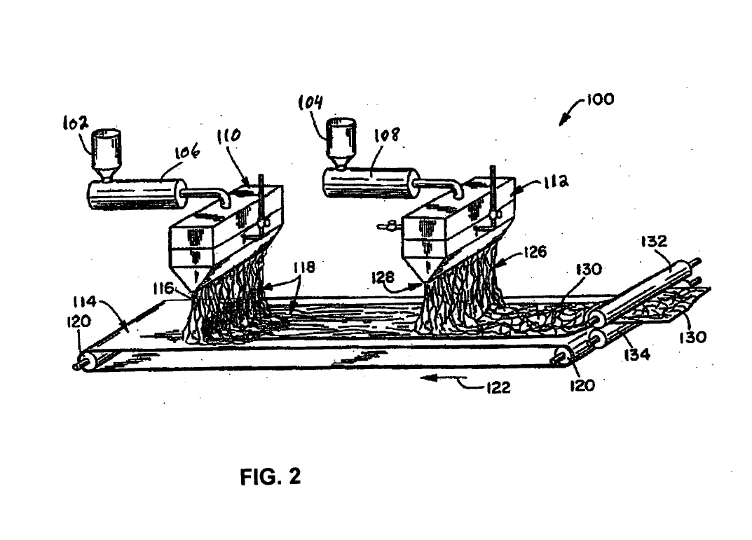

FIG. 2 is a schematic view of a process generally designated 100 for forming an exemplary textured meltblown fibrous nonwoven web material 130, which can be the textured nonwoven wiper material or a component of the textured nonwoven wiper material. In forming the meltblown fibrous nonwoven web material 130, one or more extrudable thermoplastic polymers such as are described above are introduced into pellet hoppers 102 and 104 which feed extruders 106 and 108, respectively. As known in the art, each extruder has an extrusion screw (not shown) which is driven by a conventional drive motor (not shown). As the polymer advances through the extruder due to rotation of the extrusion screw by the drive motor, it is progressively heated to a molten state, and advances through discrete heating zones of the extruders 106, 108 toward respective first and second meltblowing dieheads 110, 112. Each of the first and second dieheads 110, 112 may be a meltblowing diehead substantially as known in the art, and such are described in more detail in U.S. Pat. No. 3,849,241 to Buntin, and in U.S. Pat. No. 4,663,220 to Wisneski et al.

The first and second meltblowing dieheads 110, 112 extend substantially across a foraminous forming surface 114 in a direction which is substantially transverse to the direction of movement of the forming surface 114, and dieheads 110, 112 are arranged in a substantially vertical disposition, i.e., perpendicular to the foraminous forming surface 114, such that the thus-produced meltblown fibers are blown directly down onto the foraminous forming surface 114. The meltblowing dieheads 110, 112 each include a linear array 116, 128 of small diameter capillaries aligned along the transverse extent of the die with the transverse extent of the die being approximately as long as the desired width of the meltblown web material that is to be produced. From about 5 to about 100 such capillaries can be provided per linear inch of die face (about 2 to about 40 per centimeter), and more particularly from about 20 to about 70 capillaries per linear inch of die face (about 8 to about 28 per centimeter).

The first molten thermoplastic polymer is extruded from the capillaries 116 of the first meltblowing diehead 110 to create extruded meltblown fibers 118, which are drawn by the primary air (heated attenuating air that acts to pull or draw the meltblown fibers to attenuate them, that is, reduce their diameter) and are collected upon the foraminous forming surface 114. This foraminous surface 114 is an endless belt driven in rotating fashion by and around rollers 120 in the direction indicated by the arrow 122 in FIG. 2. Vacuum boxes (not shown) may be used to assist in retention of the meltblown fibers 118 upon the surface of the forming surface 114, and/or to assist in drawing the meltblown fibers 118 down into the interstices or foramina of the foraminous forming surface 114.

Because the meltblown fibers 118 being extruded from first diehead 110 are in a soft nascent or “just formed” condition, and are at an elevated temperature when they are deposited onto the forming surface 114, a web formed from the fibers is capable of taking on, at least in part, the shape of the forming surface 114 onto which they are deposited. As stated above, an air vacuum former or one or more “below-wire vacuum” supplies may also be used to assist in drawing the near molten meltblown fibers into and through the foramina or openings in the foraminous forming surface 114. Such a foraminous forming surface is desirably made of an open weave material. The meltblown fibers 118 from the first meltblowing diehead 110 therefore form the textured or three-dimensional exterior surface of the meltblown fibrous nonwoven web material 130. This texturing may be as three dimensional cloth-like tufts projecting from the web material's surface and formed in a generally repeating array of a plurality of spaced apart tufts, each tuft corresponding to an opening in the foraminous forming surface 114.

The size and shape of the tufts are dependent upon the type of foraminous forming surface used, the types of fibers deposited thereon, the volume of below wire air vacuum used to draw the meltblown fibers onto and into the forming surface, and other related factors. For example, the tufts could be made to project from the material's surface in the range of about 0.25 millimeters to at least about 5 millimeters, and more particularly from about 0.5 millimeters to about 3 millimeters. Generally speaking, the tufts are filled with meltblown fibers, rather than being hollow, and as such have desirable resiliency useful for scrubbing operations. As noted, it is the meltblown fibers from the first meltblowing diehead that form the textured or three-dimensional exterior surface; however, the tufts or peaks themselves may also include a certain amount of fibers from the second meltblowing diehead as these are deposited atop the first meltblown fibers and are also drawn towards or into the openings in the forming surface.

The foraminous forming surface 114 can be any type of belt or wire so long as it provides sufficient foramina or openings for penetration by some of the meltblown fibers 118 from first meltblowing diehead 110, such as for example a highly permeable forming wire. Wire weave geometry and processing conditions may be used to alter the texture or tufts of the material. The particular choice will depend on the desired tuft or peak size, shape, depth, surface tuft “density” (that is, the number of peaks or tufts per unit area), and the like. One skilled in the art could easily determine without undue experimentation the judicious balance of meltblowing attenuating air and below-wire vacuum required to achieve the desired tuft dimensions and properties. Generally, however, since a forming wire or forming surface may be used to provide the actual tufts, it is important to use a highly permeable wire to allow the meltblown fibers 118 to be drawn through the forming surface to form the peaks or tufts which form the textured exterior surface of the meltblown fibrous nonwoven web material 130. In one aspect, the wire can have an open area of between about 40 percent and about 60 percent, more particularly about 45 percent to about 55 percent, and more particularly about 49 percent to about 51 percent. This is as compared with typical forming wires for forming nonwoven web materials which are generally very dense and closed, having open areas significantly less than about 40 percent, since for conventional nonwoven web production only air is pulled through the wire and the wire serves only as a fiber collection means, and it is normally considered undesirable for the fibers to penetrate to any great extent into the forming surface itself.

An exemplary high open area forming surface is the forming wire FORMTECH™ 6 manufactured by Albany International Co. of Albany, N.Y. Such a wire has a “mesh count” of about six strands by six strands per square inch (about 2.4 by 2.4 strands per square centimeter), i.e., resulting in about 36 foramina or “holes” per square inch (about 5.6 per square centimeter), and therefore capable of forming about 36 tufts or peaks in the meltblown fibrous nonwoven web material 130 per square inch (about 5.6 peaks per square centimeter). The FORMTECH™ 6 wire as described has a warp diameter of about 1 millimeter polyester, a shute diameter of about 1.07 millimeters polyester, a nominal air permeability of approximately 41.8 m³/min (1475 ft³/min), a nominal caliper of about 0.2 centimeters (0.08 inch) and an open area of approximately 51 percent. It is within the scope of the invention that alternate forming wires and surfaces (e.g. drums, plates, etc.) may be employed. Also, surface variations may include, but are not limited to, alternate weave patterns, alternate strand dimensions, release coatings, static dissipation treatments, and the like. Another exemplary forming surface available from the Albany International Co. is the forming wire FORMTECH™ 10, which has a mesh count of about 10 strands by 10 strands per square inch (about 4 by 4 strands per square centimeter), i.e., resulting in about 100 foramina or “holes” per square inch (about 15.5 per square centimeter), and therefore capable of forming about 100 tufts or peaks per square inch (about 15.5 peaks per square centimeter) in the meltblown fibrous nonwoven web material.

It should be noted that it may be desirable to have a coating applied to the foraminous forming surface as an aid in releasing the textured surface of the meltblown fibrous nonwoven web material from the foraminous forming surface, whether the foraminous forming surface is a forming wire, belt, plate, drum former, etc. Such a release coating may include such as silicones, fluorochemical coatings, etc. as are known in the art. In another aspect mechanical or pneumatic devices may be used to aid in release. These include, but are not limited to, driven pick-off rollers such as the pick-off rollers 132, 134 shown in FIG. 2, or S-wrap rolls (i.e., a roll or assembly of rolls in close proximity to the downstream edge of the forming surface which, when driven at a higher speed than the forming surface, facilitates removal from the forming surface), air knife(s) (i.e., an assembly which provides a concentrated line or blade of high velocity air from underneath the forming surface thereby pneumatically removing the web from the forming surface), or other techniques which result in release of the web from the wire. It should be appreciated that any combination of the above aspects can also be used, as warranted by a particular application.

Returning to FIG. 2, after the first meltblowing diehead 110 deposits meltblown fibers 118 onto and into the foraminous forming surface 114, second meltblowing diehead 112 may deposit meltblown fibers 126 on top of meltblown fibers 118. As stated, the meltblown fibers 126 are collected on top of the surface of the meltblown fibers 118 that were first extruded onto the endless foraminous forming surface 114, which is rotating clockwise as indicated by the arrow 122 in FIG. 2. Vacuum boxes (not shown) can be used to assist in collection and retention of the web of meltblown fibers on the surface of the forming surface 114. Generally speaking, the tip of the meltblown dieheads 108, 110 may be from about 2 to about 16 inches (about 5 to about 41 centimeters) above the surface of the foraminous forming surface 114 upon which the fibers are collected, and more particularly, from about 6 inches to about 14 inches (about 15 to about 36 centimeters) above the surface of the foraminous forming surface. Because the meltblown fibers meltblown fibers 126 being extruded from the second diehead 112 are in a soft nascent or “just formed” condition, and are at an elevated temperature when they are deposited onto the meltblown fibers 118, they are still somewhat tacky and will therefore autogenously bond to the meltblown fibers 118, thereby forming a unitary meltblown fibrous nonwoven web material. Generally, there will be expected to be a certain amount of mixing between the fibers 118 and the fibers 126, especially at the interface between the topmost fibers 118 and the bottom most fibers 126 (i.e., where the two sets of fibers meet in the center of the meltblown web), and in any portion of the peaks or tufts which are not fully filled by the first-deposited fibers 118 may additionally be filled by fibers 26 as mentioned. On the other hand, the two exterior surfaces of the meltblown fibrous nonwoven web material 130 would be expected to be richer in either one fiber type or the other.

When two or more meltblowing dieheads are used, the fibers produced from the individual dieheads may be different types of fibers. By different types of fibers, it is meant that one or more of the size, shape, polymeric composition may differ, and furthermore that the fibers may be monocomponent or multicomponent fibers. As a specific example, and while not wishing to be bound by theory, we believe it is beneficial to obtaining the multi-modal pore size distribution to have both larger and smaller meltblown fibers in the meltblown fibrous nonwoven web material, because of the effect of fiber size on capillarity and average equivalent pore sizes. For example, it may be desirable to have larger fibers produced by the first meltblowing diehead, for example fibers having an average diameter of 10 or more microns, 15 microns, 20 microns, 25 microns or more. As another example, it may be desirable to have rather smaller fibers produced by the second meltblowing diehead, for example fibers having an average diameter of less than about 10 microns, and more particularly less than about 7 microns, and still more particularly meltblown fibers from about 2 to 6 microns.

In addition, it may be desirable where two or more meltblowing dieheads are used, to have each diehead extrude approximately the same amount of polymer such that the relative percentage of the basis weight of the meltblown fibrous nonwoven web material resulting from each meltblowing diehead is substantially the same. However, it may also be desirable to have the relative basis weight production skewed, such that one diehead or the other is responsible for the majority of the meltblown fibrous nonwoven web material in terms of basis weight. As a specific example, for a meltblown fibrous nonwoven web material having a basis weight of 1.0 ounces per square yard or “osy” (34 grams per square meter or “gsm”), it may be desirable for the first meltblowing diehead forming the textured outer surface to produce about 30 percent of the basis weight of the meltblown fibrous nonwoven web material, while one or more subsequent meltblowing dieheads produce the remainder 70 percent of the basis weight of the meltblown fibrous nonwoven web material. Generally speaking, the overall basis weight of the meltblown fibrous nonwoven web material will be from about 10 gsm to about 350 gsm, and more particularly from about 17 gsm to about 200 gsm, and still more particularly from about 25 gsm to about 150 gsm.

In addition to the above-described multiple meltblowing diehead arrangement, it may be desirable to have the meltblowing dieheads arranged at some angle with respect to the foraminous collection surface other than 90 degrees (perpendicular). Such angling of dieheads is disclosed in the above-mentioned U.S. Pat. Nos. 5,508,102 and 5,350,624 to Georger et al., which describe a coform material and process that can be made by an apparatus having dieheads arranged at angles such that the meltblown fibers are directed in an intersecting relationship to form an impingement zone whereat a secondary material is introduced to form a composite stream of the two sets of meltblown fibers and secondary material. The portion of the apparatus and method of Georger et al. describing the angled meltblowing dieheads may be adapted to form the textured meltblown fibrous nonwoven web material of the textured nonwoven wiper material herein.

Although the above exemplary process uses multiple meltblowing dieheads to produce fibers of differing sizes, this may also be produced using a single diehead. In the exemplary process taught in U.S. App. Pub. No. 20050136781, more than one type of different meltblown fibers may be produced at the same time in and by the same meltblowing diehead. In the apparatus and method taught therein, at least two fluid supplies (such as polymer supplies) are used in communication with the die. First counterbores allow fluid communication between first extrusion capillaries and the first fluid or polymer supply, and second counterbores allow fluid communication between the second extrusion capillaries and second fluid or polymer supply, so that the one diehead is capable of extruding distinct first and second meltblown fibers. As stated above, where multiple meltblowing diehead are utilized there will be expected a certain amount of mixing of fiber types but with surfaces that are rich in one fiber type or the other. However, where a single meltblowing diehead is utilized, the two fiber types would be expected to be substantially uniformly distributed throughout the meltblown fibrous nonwoven web material.

As stated, the textured nonwoven wiper material includes a meltblown fibrous nonwoven web material having a three dimensional surface texture and a multi-modal pore size distribution, and this textured meltblown fibrous nonwoven web material by itself is highly suitable as the textured nonwoven wiper material of the invention. However, the textured nonwoven wiper material may also include one or more additional materials to provide different or additional functional benefits to the textured nonwoven wiper material. As an example, it may be desired to provide a certain amount of separation between a user's hands and a moistening or saturating liquid that has been applied to the wiper material, or, where the wiper material is provided as a dry wiper, to provide separation between the user's hands and a liquid spill that is being cleaned up by the user. In such cases, it may be desirable to have an additional nonwoven web material or a film material, such as a polymeric film material, laminated to one of the surfaces of the meltblown fibrous nonwoven web material to provide physical separation and/or provide liquid barrier properties.

As another example, it may be desirable to include one or more other materials or layers in the three-dimensionally textured nonwoven wiper material to provide other functional benefits. For instance, other fibrous web materials, such as other fibrous nonwoven web materials, may be included to provide for increased absorbent capacity, either for the purposes of absorbing larger liquid spills, or for the purpose of providing a pre-moistened wiper having more wiping liquid available than may be provided alone in the pre-moistened meltblown fibrous nonwoven web material portion of the three-dimensional textured nonwoven wiper material.

As stated, the above-described additional materials may be such as film materials or nonwoven web materials, such as spunbond webs, other meltblown webs, carded web materials, coform webs, airlaid webs, and the like. Any such additional materials may be produced using the above-mentioned polymeric materials, and/or such additional materials may comprise cellulosic fibers such as pulp fibers, and may additionally contain particulate material such as absorbent polymeric materials known to the skilled artisan as superabsorbent polymers. Such additional materials may desirably be attached to the meltblown fibrous nonwoven web material of the textured nonwoven wiper material by methods as are known to one skilled in the art, such as by thermal or adhesive lamination or bonding with the individual materials placed in face to face contacting relation. Such lamination may be essentially coextensive with the contacting surface area of the materials, may be at discrete spaced-apart points, may be in lines, or patterns, or along the edges or perimeter of the materials being joined.

The textured nonwoven wiper material, whether consisting essentially of the meltblown fibrous nonwoven web material having at least one three-dimensionally textured surface, or whether additionally including other such materials as described above, may be provided in the form of a single packaged wiper or as multiple wipers provided in a package in the form of a stack of wipers, or as a roll of wipers provided in a canister. Whether provided as single wipers or multiple wipers, the wipers may be provided in a dry form, or provided as a pre-moistened or pre-saturated wiper including a wiping or cleaning fluid, such as a cleaning or wiping solution.

The pre-moistened wipers can be maintained over time in a sealable or re-sealable container such as, for example, a bucket having an attachable lid, in sealable or re-sealable plastic pouches or bags, such as pouches or bags having a zipper or other type resealing mechanism, in canisters, jars, tubs and so forth. Desirably the pre-moistened wipers are maintained in a re-sealable container. The use of a re-sealable container is particularly desirable when using volatile liquid compositions since substantial amounts of liquid may evaporate while using the first sheets thereby leaving the remaining sheets with an insufficient amount of liquid. Exemplary re-sealable containers and dispensers include such as those described in U.S. Pat. No. 4,171,047 to Doyle et al., U.S. Pat. No. 4,353,480 to McFadden, U.S. Pat. No. 4,778,048 to Kaspar et al., U.S. Pat. No. 4,741,944 to Jackson et al., and U.S. Pat. No. 5,595,786 to McBride et al., the entire contents of which are incorporated herein by reference.

The wipers may be incorporated or oriented in the container as desired and/or folded as is known in the art as desired in order to improve ease of use and/or ease of dispensing from the container. Such folded configurations are well known to those skilled in the art and include wipers or wiping sheets that are folded in configurations such as c-folds, z-folds, quarter-folds and the like. Such a stack of folded wipers may be placed inside a container, such as a plastic tub, in a pre-moistened condition to provide a package of wet wipers for eventual sale to the consumer. Alternatively, the wipers may include a continuous strip or sheet of wiper material arranged in either a stack or in a roll form, the continuous wiper sheet having perforations or another such easy-separation mechanism whereby the continuous sheet of wiper material may be dispensed as individual wiper sheets by tearing the perforation at each wiper.

With regard to pre-moistened wipers, a selected amount of liquid may be added to a container that contains the wipers, such that the wipers contain the desired amount of liquid. As mentioned above, the wipers may be stacked and placed in a container and the pre-moistening or saturating liquid may be subsequently added to the container, thus wetting or moistening the wipers. The wiper may then be used to wipe a surface and may also act as a delivery device to deliver and apply a cleaning liquid or other treating liquid to a surface. The pre-moistened or saturated wipers may then be used to treat various surfaces. The term “treating” a surface is used in the broad sense to include such as wiping, polishing, cleaning, washing, swabbing, scrubbing, scouring, disinfecting, sanitizing and the like. In addition, the term “treating” a surface is intended to include such actions as applying a liquid or liquid containing active agents to a surface, wherein it is desired that some or all of the treating liquid remain on the surface or be absorbed into the surface.

The amount and composition of the any such liquid added to the wiper may vary depending on the desired end-use application and/or intended function of the wipers. As used herein the term “liquid” includes without limitation solutions, emulsions, suspensions and so forth. Thus, liquids may include and/or contain one or more of disinfectants; antiseptics; diluents; surfactants, such as anionic, cationic and nonionic surfactants; waxes; antimicrobial agents; sterilants; sporicides; germicides; bactericides; fungicides; virucides; protozoacides; algicides; bacteriostats; fungistats; virustats; sanitizers; antibiotics; pesticides; and so forth. In addition, numerous cleaning compositions and compounds are known in the art such as soaps, detergents, alcohols and degreasers, and combinations thereof, may be used in connection with the textured nonwoven wiper material of the present invention, either with or without the other ingredients types listed above. The liquid may also contain lotions, moisturizers and/or medicaments. Exemplary uses for the textured nonwoven wiper material of the invention include use as baby wipes, hand wipes, face wipes, cosmetic wipes, household wipes, industrial wipes, medical wipes and the like.

When provided in a pre-moistened or wetted condition, the amount of liquid contained within each textured nonwoven wiper material may vary depending upon the type of material being used to provide the pre-moistened wiper, the basis weight and density of the wiper material, the type of liquid being used, the type of container being used to store the wetted wipers, and the desired end use of the wet wiper. Generally, each pre-moistened wiper may contain from about 50 weight percent to about 900 weight percent (based on weight of the wiper material prior to being moistened), depending on the desired end use. For example, for wiping household or industrial countertops, glass or other smooth, generally low-porosity surfaces, a wiper having a moistening level or saturation level of about 150 weight percent to about 650 weight percent of the dry wiper is desirable. For cleaning more expansive surfaces, or surfaces that tend to absorb more liquid, or cleaning situations requiring more prolonged wiping with a single wiper (wherein a substantial amount of liquid might be expected to evaporate during the wiping operation), the saturation level may desirably range from about 300 to about 900 weight percent liquid based on the dry weight of the wiper material; more desirably, such saturation level may range from about 500 weight percent to about 800 weight percent of the dry wiper. While lesser amounts of liquid than those mentioned above may be adequate for certain wiping circumstances, generally it should be noted that the cleaning sheet may be too dry and may not adequately perform. On the other hand, where the amount of liquid is greater than the above-mentioned ranges, the wiper may be oversaturated and tend to be soggy or drip liquid freely after being dispensed from a container, and/or the liquid may pool in the bottom of the container.

While not wishing to be bound by theory, we believe the textured wiper having a meltblown web with the above-described multi-modal pore size distribution peaks provides unique and specific advantages to the wiper. A wiper material having a significant population of both smaller and larger pores provides for a wiper having a high capacity for containing added moistening liquid, such as a cleaning fluid or other saturant, while at the same time be capable of releasing a large portion of the added liquid for use upon initial application of pressure or initial wiping. For example, in a wiper made from a wiper material having only one major pore size peak, if the majority of the pores are very small, then the wiper material should hold the saturant or moistening liquid well during shipping and storage, but would have a diminished ability to release the moistening liquid upon use. That is, more effort will be required by the user to express the liquid from such a wiper for cleaning and wiping operations, and/or the majority of the moistening liquid will fail to be released from the wiper material.

On the other hand, for a wiper made from a wiper material having only one major pore size peak, where the majority of the pores are very large and without a substantial population of smaller pores, then the wiper material will fail hold the saturant or moistening liquid well. For such a wiper, the moistening liquid will have a tendency to migrate through the wiper under the impetus of gravity. For a container or package of wipers, this presents the problem wherein the wiper materials nearest the top of the package do not retain enough of the liquid, while the wiper materials nearest the bottom of the package are literally dripping with excess moistening liquid. In terms of a single such wiper made from a wiper material having the majority of pores being very large, this may also be undesirable from the standpoint of a wiping operation, in that such a wiper tends to “gush” or release too much of its saturant or liquid upon first contact with the surface being wiped, rather than releasing the liquid in a controlled fashion as the user passes the wiper across the surface and in contact with the surface.

### EXAMPLES

As a specific example of an embodiment of the foregoing, textured nonwoven wiper materials were produced as follows. Examples 1, 2 and 3 were textured meltblown fibrous nonwoven web materials produced by meltblowing a blend of polypropylene and polybutylene polymers in an 85 percent to 15 percent ratio, polypropylene to polybutylene. The polypropylene polymer was a commercially available polymer designated as PF-015 from Basell USA, Inc. of Wilmington, Del. and the polybutylene polymer was a commercially available ethylene copolymer of 1-butene having about 5 percent ethylene and designated as DP8911, also from Basell USA, Inc. of Wilmington, Del. The two polymers were melted together in and by respective first and second extruders at approximately 490° F. (about 255° C.) and supplied to a respective first and second meltblowing dieheads arranged in series over a foraminous forming surface essentially as described above. The meltblown primary air was also approximately 490° F. (about 255° C.).

All three Examples had a basis weight of approximately 34 gsm.

For Examples 1 and 3, the extruder and pumps serving the first and second meltblowing dieheads were run at a 1-to-1 ratio of about 1 pound per inch per hour or PIH (about 17.9 kg/meter/hour) of polymer throughput. For Example 2, the extruder and pumps serving the first and second meltblowing dieheads were run at about a 3-to-1 ratio such that the first meltblowing diehead extruded about 3 PIH (about 53.6 kg/meter/hour) while the second meltblowing diehead extruded about 1 PIH (about 17.9 kg/meter/hour). Therefore, for Examples 1 and 3 the meltblown fibrous nonwoven web materials thus produced would have a representative basis weight wherein the meltblown fibers from the first meltblowing diehead and the meltblown fibers from the second meltblowing diehead were approximately equally represented by weight of the material; i.e., about 17 gsm each of the 34 gsm meltblown materials.

On the other hand, for Example 2, the extruder and pumps serving the first meltblowing diehead were run at a polymer throughput approximately 3 times higher than the second meltblowing diehead such that the meltblown fibrous nonwoven web material thus produced would have a representative basis weight wherein the meltblown fibers from the first meltblowing diehead dominant in the textured exterior surface represented about 25.5 gsm of the 34 gsm total basis weight, and the meltblown fibers from the second meltblowing diehead dominant in the second exterior surface of the meltblown fibrous nonwoven web material represented about 8.5 gsm of the 34 gsm total basis weight of the meltblown fibrous nonwoven web material.

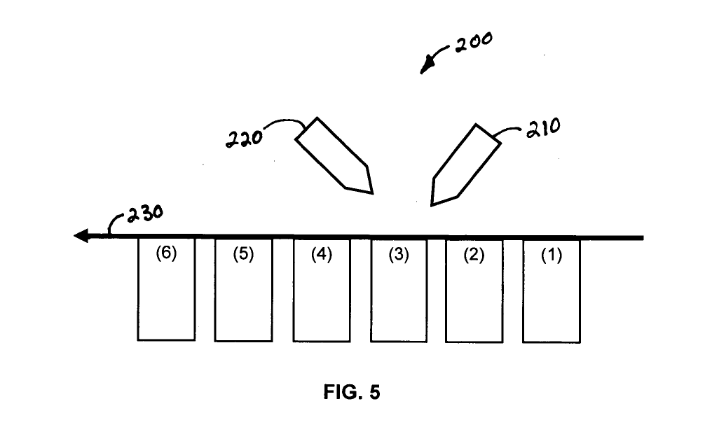

The Example materials 1-3 were produced using a multiple diehead meltblowing apparatus having two meltblowing dieheads that were capable of being oriented at an angle to the foraminous forming surface, such as is described above. Moving ahead momentarily to FIG. 5, this figure illustrates a schematic of the multiple diehead meltblowing process 200 used to produce the Example textured meltblown fibrous nonwoven web materials. As shown in FIG. 5, the two meltblowing dieheads 210 and 220 are oriented at an angle from a vertical line rather than being oriented in an essentially vertical fashion (i.e., perpendicular to the foraminous forming surface) as was described with respect to the dieheads 110, 112 in FIG. 2. As shown, first meltblowing diehead 210 is oriented at an angle of about 35 degrees with respect to the vertical plane of the process. Second meltblowing diehead 220 is oriented at an angle of about 45 degrees with respect to the vertical plane of the process. The meltblowing dieheads are shown directed at converging or intersecting angles (toward one another) in FIG. 5, but it should be noted that they may also be directed at essentially non-intersecting angles such as having parallel orientation or having diverging angles. For production of Examples 1-3, the two meltblowing dieheads were oriented as shown in FIG. 5, with first diehead 210 at about 35 degrees from vertical and second diehead at about 45 degrees from vertical.

Generally speaking, where angled dieheads are used the two meltblowing dieheads may be oriented at angles from about 10 degrees from vertical to about 60 degrees from vertical. Larger and smaller angles are possible, but where a horizontal foraminous forming surface is used angles greater than about 60 degrees from vertical may make fiber capture and collection upon the foraminous forming surface less efficient. With respect to smaller angles, fiber collection upon a horizontal foraminous forming surface is of course not a concern and smaller angles may be utilized, and/or combinations of one substantially vertical meltblowing diehead with one angled meltblowing diehead may be used.

The meltblowing dieheads may also be adjusted with respect to their vertical height over the foraminous forming surface. This forming height or forming distance may generally range from about 2 inches to about 16 inches (about 5 to about 41 centimeters) or more for a given meltblowing diehead. More particularly, the forming height will generally range from about 4 inches to about 14 inches (about 10 to about 36 centimeters), and still more particularly from about 6 inches to about 11 inches (about 15 to about 28 centimeters). Generally, a lower relative forming height for the first meltblowing diehead relative to subsequent meltblowing dieheads may be desirably increase the surface texture of the textured exterior surface of the meltblown wiper, and/or may increase the coarseness of that textured surface to produce wipers for heavier duty scrubbing. The forming heights for Examples 1-3 are shown listed in TABLE 1 below, with “D1” indicating the first meltblowing diehead 210 and “D2” indicating the second meltblowing diehead 220. For production of Examples 1-3, the first meltblowing diehead 210 was run substantially lower than the second meltblowing diehead 220, to assist in having the meltblown fibers from the first meltblowing diehead take on the form of the forming surface and in an attempt to have the fibers of the first exterior surface of the materials have a higher concentration of rather larger fibers.

Regarding relative fiber sizes, both surfaces of Examples 1 and 3 were viewed under a microscope capable of measuring fiber diameters in microns. For Example 1, the first exterior surface (i.e., surface primarily deposited by the first meltblowing diehead) had a rather high population of larger meltblown fibers ranging from about 11 to about 33 microns, with an average of about 17.5 microns, although an occasional much smaller fiber in the 2-10 micron range was also visible. Also for Example 1, the second exterior surface (i.e., surface primarily deposited by the second meltblowing diehead) had a rather high population of smaller meltblown fibers ranging from about 1.5 to about 10 microns, with an average of about 4.5 microns, although an occasional much larger fiber in the 10 to 20+ micron range was visible. Similarly for Example 3, the first exterior surface had more larger fibers (averaging about 17 microns) and the second exterior surface had more smaller fibers (averaging about 6.5 microns), although again on the first surface small fibers were also visible, and on the second surface large fibers were also visible.

As shown in FIG. 5, arrow 230 represents a foraminous forming surface such as described above and the arrow indicates the direction of material production (direction of movement of the foraminous forming surface). Situated under the foraminous forming surface are below-wire vacuum boxes or vacuum zones (1)-(6). The vacuum zones may be independently increased or decrease one relative to another to produce either rather more or rather less vacuum relative to each other. As stated above, the below-wire vacuum may desirably be used to cause the meltblown fibers, particularly the fibers (not shown in FIG. 5) from first meltblowing diehead 210 to penetrate deeper into the foramina or spaces in the forming surface. That is, higher vacuum generally tends to produce taller peaks and/or peaks having a higher concentration or density of meltblown fibers, although these factors also depend on the size of the foramina. However, generally speaking, the vacuum zones that are not located below a meltblowing diehead function mainly to retain the meltblown web upon the wire as it travels, rather than causing any further substantial penetration into the foramina in the forming surface. The relative vacuum zone settings for Examples 1-3 are shown in TABLE 1 below (in units of inches of water). Particularly, vacuum zone (3) is the main vacuum zone immediately under the deposition area for the first meltblowing diehead, and so it was increased relative to some of the other vacuum zones that were responsible primarily for web retention.

Examples 1 and 3 were produced by meltblowing the fibers onto a FORMTECH™ 8 foraminous forming surface, available from Albany International Co. of Albany, N.Y. The FORMTECH™ 8 foraminous forming surface or forming wire has a mesh count of about 8 strands by 8 strands per square inch (about 3.1 by 3.1 strands per square centimeter), i.e., resulting in about 64 foramina or “holes” per square inch (about 10 per square centimeter), and therefore resulting in the meltblown fibrous nonwoven web material of Examples 1 and 3 each having about 64 tufts or peaks in the meltblown fibrous nonwoven web materials per square inch (about 10 peaks per square centimeter). Example 2 was produced by meltblowing the fibers onto a FORMTECH™ 10 foraminous forming surface, available from Albany International Co. of Albany, N.Y. The FORMTECH™ 10 foraminous forming surface or forming wire has a mesh count of about 10 strands by 10 strands per square inch (about 4 by 4 strands per square centimeter), i.e., resulting in about 100 foramina or “holes” per square inch (about 15.5 per square centimeter), and therefore resulting in the meltblown fibrous nonwoven web material of Example 2 having about 100 tufts or peaks in the meltblown fibrous nonwoven web material per square inch (about 15.5 peaks per square centimeter).

The Example 1-3 meltblown webs all visibly exhibited the texture “mirroring” mentioned above wherein the second surface of the material exhibited peaks that were offset or between peaks on the first exterior surface of the material. Therefore, for purposes of the peak to valley ratio, the valley depth used to calculate T/D was the sum of the valley depths from both exterior surfaces. The overall material valley depth for Example 1 was about 0.9 millimeters and Example 1 overall thickness was about 1.2 millimeters. Thus, the peak to valley ratio for Example 1 material was approximately 1.3. For Example 3, the overall material valley depth was about 1.7 millimeters and Example 2 overall thickness was about 2 millimeters. Thus, the peak to valley ratio for Example 2 material was approximately 1.2. Example 2 was not tested for peak to valley ratio due to insufficient availability of material at the time of testing.

TABLE 1

| Example | 1 | 2 | 3 |
|---|---|---|---|
| D1 forming height (in) | 6.5 | 10 | 6.5 |
| D2 forming height (in) | 9.5 | 13 | 9.5 |
| Zone (1) (in H2O) | 1 | 0 | 1 |
| Zone (2) (in H2O) | 1 | 4 | 1 |
| Zone (3) (in H2O) | 11 | 4 | 11 |
| Zone (4) (in H2O) | 2 | 4 | 2 |
| Zone (5) (in H2O) | 2 | 2 | 2 |
| Zone (6) (in H2O) | 2 | 3 | 2 |

Two Comparative nonwoven wiper materials were obtained. Comparative 1 was a meltblown nonwoven wiper material commercially available from the Kimberly-Clark Corporation, Dallas, Tex., and sold business-to-business for conversion into pre-moistened wipes. Comparative 1 was a polypropylene meltblown similar to the nonwoven wipers taught in the above-mentioned U.S. Pat. No. 4,833,003 to Win et al., and included a meltblown nonwoven web layer having larger or coarser meltblown fibers meltsprayed upon one exterior surface to provide a coarse surface suitable for abrasive scrubbing. Comparative 2 was also a nonwoven wiper material having a meltblown nonwoven web layer with larger or coarser meltblown fibers meltsprayed upon one exterior surface, providing a coarse scrubbing surface. Comparative 2 material was commercially available from E.I. du Pont de Nemours and Company, Wilmington, Del., and sold business-to-business for conversion into pre-moistened wipes. Comparatives 1 and 2 did not have a three-dimensional surface texture.

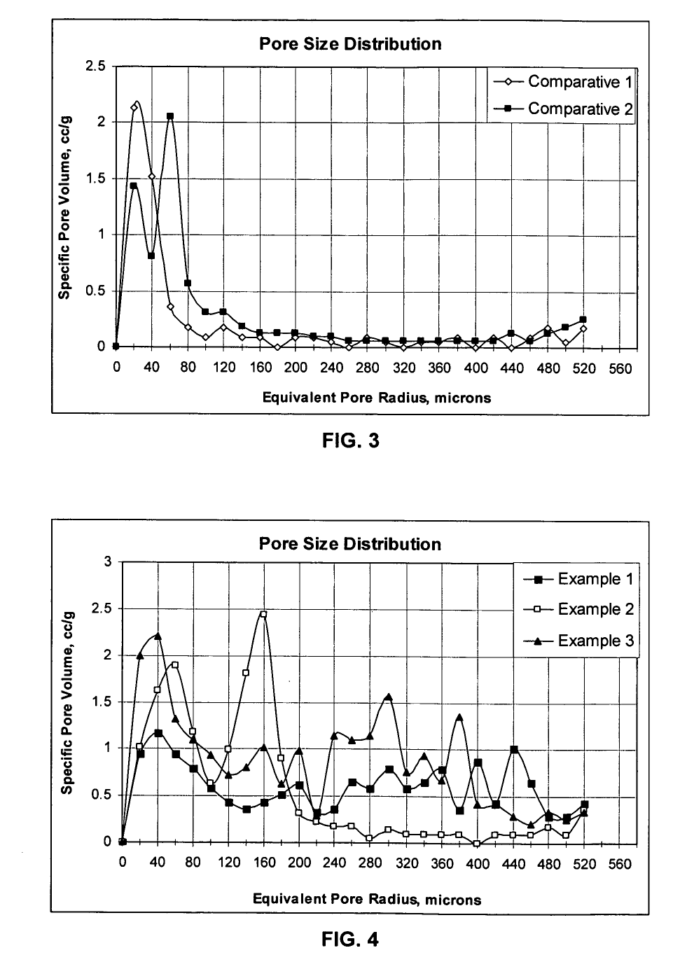

The nonwoven wiper materials of Examples 1-3 and Comparative 1 and 2 were tested for pore size distribution. Mean equivalent pore radius peaks were identified and the population of equivalent pore radius peaks in microns were plotted against the specific pore volume of the nonwoven web materials in cubic centimeters per gram of the nonwoven web material (that is, the measured pore volume was normalized on the basis of per-gram of the sample tested to account for differences in weight of a particular sample tested). These data were plotted in the graphs shown in FIG. 3 for Comparative materials 1 and 2, and in FIG. 4 for Examples 1-3. As can be readily seen in FIG. 3, Comparative material 1 has one large pore size peak beginning at zero microns equivalent pore radius, peaking at about 20 microns equivalent pore radius, and ending at about 100 microns equivalent pore radius where the curve hits a nadir or low point and begins back up again.

As mentioned, the graphs in FIG. 3 represent the equivalent pore radius in microns (“μ”) plotted against the specific pore volume in cubic centimeters per gram or cc/g of material. These data are shown below in TABLE 2, along with the sum of all of the specific pore volumes for each of the five materials listed at the bottom as “Total cc/g”. As also mentioned above, a major pore size peak should encompass at least about 10 percent of the total pore volume of the wiper material, and desirably more than 10 percent, such as at least about 11 percent, 12 percent, 13 percent or more, and, depending on application it may be desirable for one or more of the major pore size peaks to encompass much larger percentages of the wiper material's pore volume. Returning to the graph of Comparative 1 material in FIG. 3, as noted it can be seen that this material has a large peak between about zero and about 100 microns. The pore volume for that peak may be calculated by summing the area under the curve and splitting shared datapoints for adjacent peaks (i.e., the pore volume at a nadir datapoint marking the end of one peak and the beginning of a next peak—an example of this can be very clearly seen at the 40 micron datapoint for Comparative 2 in FIG. 3). For example, the specific pore volume for the sole large peak for Comparative 1 may be calculated as:
Pore volume=0.5*(0)+2.128+1.513+0.356+0.178+0.5*(0.089)=4.22 cc/g.

The percentage pore volume encompassed by this peak is then the total material specific pore volume divided by the peak specific pore volume and expressed as a percentage by multiplying by 100. Here, the percent pore volume encompassed by the one large peak evident in Comparative 1 is 100 percent*(4.22/5.7) or about 74 percent and is therefore a “major peak” as defined herein. However, this is the only major peak for Comparative 1. It does have other small peaks, for example the small peak starting about 100 microns and ending about 140 microns, and the small peak starting about 440 microns and ending about 500 microns. These small peaks encompass about 4.7 percent and 5.1 percent of the total pore volume, respectively.

TABLE 2

| Comparatives | | | | Examples | | | | | |
|---|---|---|---|---|---|---|---|---|---|
| Comparative 1 | | Comparative 2 | | Example 1 | | Example 2 | | Example 3 | |
| pore | pore | pore | pore | pore | pore | pore | pore | pore | pore |
| radius | volume | radius | volume | radius | volume | radius | volume | radius | volume |
| (μ) | (cc/g) | (μ) | (cc/g) | (μ) | (cc/g) | (μ) | (cc/g) | (μ) | (cc/g) |
| 0 | 0.000 | 0 | 0.000 | 0 | 0.000 | 0 | 0.000 | 0 | 0.000 |
| 20 | 2.128 | 20 | 1.434 | 20 | 0.945 | 20 | 1.011 | 20 | 1.999 |
| 40 | 1.513 | 40 | 0.809 | 40 | 1.162 | 40 | 1.624 | 40 | 2.205 |
| 60 | 0.356 | 60 | 2.054 | 60 | 0.944 | 60 | 1.895 | 60 | 1.314 |
| 80 | 0.178 | 80 | 0.560 | 80 | 0.799 | 80 | 1.173 | 80 | 1.102 |
| 100 | 0.089 | 100 | 0.311 | 100 | 0.581 | 100 | 0.632 | 100 | 0.933 |
| 120 | 0.178 | 120 | 0.311 | 120 | 0.436 | 120 | 0.993 | 120 | 0.721 |
| 140 | 0.089 | 140 | 0.187 | 140 | 0.363 | 140 | 1.805 | 140 | 0.806 |
| 160 | 0.089 | 160 | 0.125 | 160 | 0.436 | 160 | 2.437 | 160 | 1.018 |
| 180 | 0.000 | 180 | 0.125 | 180 | 0.508 | 180 | 0.903 | 180 | 0.636 |
| 200 | 0.089 | 200 | 0.125 | 200 | 0.617 | 200 | 0.316 | 200 | 0.975 |
| 220 | 0.089 | 220 | 0.093 | 220 | 0.327 | 220 | 0.226 | 220 | 0.297 |
| 240 | 0.045 | 240 | 0.093 | 240 | 0.363 | 240 | 0.181 | 240 | 1.145 |
| 260 | 0.000 | 260 | 0.062 | 260 | 0.654 | 260 | 0.181 | 260 | 1.102 |
| 280 | 0.089 | 280 | 0.062 | 280 | 0.581 | 280 | 0.045 | 280 | 1.145 |
| 300 | 0.045 | 300 | 0.062 | 300 | 0.799 | 300 | 0.135 | 300 | 1.569 |
| 320 | 0.000 | 320 | 0.062 | 320 | 0.581 | 320 | 0.090 | 320 | 0.763 |
| 340 | 0.045 | 340 | 0.062 | 340 | 0.654 | 340 | 0.090 | 340 | 0.933 |
| 360 | 0.045 | 360 | 0.062 | 360 | 0.799 | 360 | 0.090 | 360 | 0.678 |
| 380 | 0.089 | 380 | 0.062 | 380 | 0.363 | 380 | 0.090 | 380 | 1.357 |
| 400 | 0.000 | 400 | 0.062 | 400 | 0.872 | 400 | 0.000 | 400 | 0.424 |
| 420 | 0.089 | 420 | 0.062 | 420 | 0.436 | 420 | 0.090 | 420 | 0.424 |
| 440 | 0.000 | 440 | 0.125 | 440 | 1.017 | 440 | 0.090 | 440 | 0.297 |
| 460 | 0.089 | 460 | 0.062 | 460 | 0.654 | 460 | 0.090 | 460 | 0.212 |
| 480 | 0.178 | 480 | 0.125 | 480 | 0.291 | 480 | 0.181 | 480 | 0.339 |
| 500 | 0.045 | 500 | 0.187 | 500 | 0.291 | 500 | 0.090 | 500 | 0.254 |
| 520 | 0.178 | 520 | 0.249 | 520 | 0.436 | 520 | 0.361 | 520 | 0.339 |
| Total cc/g | 5.7 | Total cc/g | 7.5 | Total cc/g | 15.9 | Total cc/g | 14.8 | Total cc/g | 23.0 |

Turning to Comparative 2 and the three Example materials, it can be seen from FIG. 3 and FIG. 4 that each of these materials includes a plurality of larger appearing peaks. The Comparative 2 material has a first large peak centered around 20 microns running from zero microns to 40 microns, and a second large peak centered around 60 microns that runs from 40 microns to 100 microns. The Example 1 material has numerous larger peaks, the first centered around 20 microns (running from zero to 100 microns), and others including the peaks evident on the graph that are centered at 200 microns (running from 140 to 220 microns) and centered at 440 (running from 420 to 480 microns). The Example 2 material has two large peaks, one centered at 60 microns (running from zero to 100 microns) and another centered at 160 microns (running from 100 to 200 microns). The Example 3 material has larger peaks centered at 40 microns (running from zero to 120 microns), centered at 160 microns (running from 120 to 180 microns), and centered at 300 microns (running from 280 to 320 microns).

As shown in the chart TABLE 3 below, all of these just-described larger peaks in the Comparative 2 wiper material, and the wiper materials of Examples 1, 2 and 3 are major peaks as described herein. That is, each of the peaks identified in TABLE 3 below encompass a specific pore volume that is at least about 10 percent of the total material's specific pore volume. However, there are distinct differences in the distribution of the peaks themselves, as between the Comparative 2 material and the materials of Examples 1, 2 and 3. That is to say, the multi-modal pore size distribution of the Example materials exhibits major pore size peaks that are distributed throughout the spectrum of equivalent pore radius size, while the Comparative 2 material has only major pore size peaks that are quite crowded together only in the extreme low end of the spectrum of equivalent pore radius sizes. As an example, Comparative 2 has two major pore size peaks having centers that are separated by only 40 microns with respect to equivalent pore radius. Contrast that with the major pore size peaks of each Example material. For instance, for Example 1, the first and second listed major peak centers are separated by 180 microns, the second and third listed major peak centers by 240 microns, and the first and third listed peak centers are separated by 420 microns equivalent pore radius. The two major pore size peaks of Example 2 are separated by 100 microns. And for Example 3, the first and second listed major peak centers are separated by 120 microns, the second and third listed major peak centers by 140 microns, and the first and third listed peak centers are separated by 260 microns equivalent pore radius.

As stated above, and again, while not wishing to be bound by theory, we believe there are distinct advantages to the multi-modal pore size distribution of the textured nonwoven wiper material being relatively spread through the equivalent pore radius size spectrum. For Comparative 2, having only 40 microns equivalent pore radius between the to major peak centers (and, indeed, the majority of the pores well below 100 microns) indicates there will be little dissimilarity in terms of liquid handling behavior as between the two peaks or pore population concentrations. In contrast, the textured nonwoven wiper materials of the Examples have a broad distribution of equivalent pore radius population concentrations, and therefore will have a broader range of liquid handling behavior, such as good liquid retention/holding capacity due to significant populations of smaller pores (under about 100 microns), to good quick release or initial liquid gush capability due to significant populations of larger pores.

TABLE 3

| | Peak ID | | |
|---|---|---|---|
| Material | (center, μ) | Spec. Vol (cc/g) | % total Spec. Vol |
| Comparative 2 | 20 | 1.84 | 24.4 |
| | 60 | 3.17 | 42.1 |
| Example 1 | 20 | 4.14 | 26.0 |
| | 200 | 1.91 | 12.0 |
| | 440 | 2.03 | 12.8 |
| Example 2 | 60 | 6.02 | 10.9 |
| | 160 | 2.50 | 44.6 |
| Example 3 | 40 | 7.91 | 34.4 |
| | 160 | 7.91 | 34.4 |
| | 300 | 2.52 | 11.0 |

The textured nonwoven wiper materials disclosed herein are highly suitable for use as individual sheets, and may be provided in a pre-wetted or pre-moistened “ready-to-use” state, or may be provided in a substantially dry state for an end-user to moisten or saturate with some preferred liquid. Examples of such wiping products include, but are not limited to, wipers for medical healthcare settings, human personal care use, pet care uses, industrial or commercial cleaning uses, household cleaning uses, and the like.

In addition, other uses of the textured nonwoven wiper material are contemplated and the wiper material may be used in conjunction with other materials. For example, while the textured nonwoven wiper material described herein has primarily been discussed with respect to use of the textured surface meltblown nonwoven web as a single wiping sheet layer, it is contemplated that the meltblown nonwoven web may desirable be joined to other types of web layers. As examples, the textured surface meltblown nonwoven web may be joined or laminated to other absorbent material layers, for example nonwoven layers such as other meltblown layers, carded web layers, spunbond layers, coform layers, airlaid web layers, and the like.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A textured nonwoven wiper material comprising a meltblown nonwoven web having a first exterior surface and a second exterior surface, wherein at least said first exterior surface has a three-dimensional surface texture, said meltblown nonwoven web having a multi-modal pore size distribution having at least two major peaks, at least a first of said major peaks having an equivalent pore radius less than about 100 microns and at least a second of said major peaks having an equivalent pore radius greater than about 100 microns.

2. The textured wiper material of claim 1 wherein said meltblown nonwoven web comprises meltblown fibers comprising polyolefin thermoplastic polymer.

3. The textured wiper material of claim 2 wherein said meltblown nonwoven web comprises meltblown fibers comprising polypropylene thermoplastic polymer.

4. The textured wiper material of claim 1 wherein said equivalent pore radius of said first major peak is less than about 80 microns and wherein said equivalent pore radius of said second major peak is greater than about 120 microns.

5. The textured wiper material of claim 4 wherein said equivalent pore radius of said first major peak is about 60 microns or less and wherein said equivalent pore radius of said second major peak is greater than about 140 microns.

6. The textured wiper material of claim 2 wherein said meltblown fibers further comprise polybutylene polymer.

7. The textured wiper material of claim 6 wherein said meltblown fibers comprising polybutylene polymer are present substantially only on said first exterior surface.

8. A wiper comprising the textured wiper material of claim 1.

9. The wiper of claim 8 wherein said wiper further includes from about 50 percent to about 900 percent by weight of the wiper of a moistening liquid.

10. A package of wipers containing a plurality of the wipers of claim 9.

11. A textured nonwoven wiper material comprising a meltblown nonwoven web having a first exterior surface and a second exterior surface, wherein at least said first exterior surface has a three-dimensional surface texture, said meltblown nonwoven web having a multi-modal pore size distribution having at least a first major peak having an equivalent pore radius and a second major peak having an equivalent pore radius, and wherein said second major peak equivalent pore radius at least about 60 microns greater than said equivalent pore radius of said first major peak.

12. The textured wiper material of claim 11 wherein said meltblown nonwoven web comprises meltblown fibers comprising polyolefin thermoplastic polymer.

13. The textured wiper material of claim 12 wherein said meltblown nonwoven web comprises meltblown fibers comprising polypropylene thermoplastic polymer.

14. The textured wiper material of claim 11 wherein said second major peak equivalent pore radius at least about 70 microns greater than said equivalent pore radius of said first major peak.

15. The textured wiper material of claim 11 wherein said second major peak equivalent pore radius at least about 80 microns greater than said equivalent pore radius of said first major peak.

16. The textured wiper material of claim 11 wherein said second major peak equivalent pore radius at least about 90 microns greater than said equivalent pore radius of said first major peak.

17. The textured wiper material of claim 11 wherein said second major peak equivalent pore radius at least about 100 microns greater than said equivalent pore radius of said first major peak.

18. A wiper comprising the textured wiper material of claim 11.

19. The wiper of claim 18 wherein said wiper further comprises from about 50 percent to about 900 percent by weight of the wiper of a moistening liquid.

20. A package of wipers containing a plurality of the wipers of claim 19.
